(19) United States
(12) Patent Application Publication
(10) Pub. No.: US 2005/0001940 A1
(43) Pub. Date: Jan. 6, 2005

(54) Token-based TV viewing regulator

(76) Inventor: Thomas Leslie Layne JR., Enid, OK (US)

Correspondence Address: MARTIN S. HIGH, P.O. BOX 217, STILLWATER, OK, 74076, US

(21) Appl. No.: 10/844,632

(22) Filed: May 13, 2004

Related U.S. Application Data
(60) Provisional application No. 60/469,998, filed on May 13, 2003.

(51) Int. Cl. H04N 7/16; H04N 5/64

(52) U.S. Cl. 348/787; 348/789

(57) ABSTRACT

The Token-Based TV Viewing Regulator, is an electronic, token activated device that automatically electronically interrupts the television signal to the television monitor. The tokens inserted into the device will allow the signal to pass to the television for a predetermined time period. As an example of its use, a child can earn television viewing time by receiving tokens for chores or other acts agreed upon with an adult. The child then has the choice of spending the tokens to view television or saving the tokens for a later, extended viewing time.

### CROSS-REFERENCE TO RELATED APPLICATIONS

This application claims the benefit of U.S. Provisional Application No. 60/469,998, titled Token-based TV viewing regulator, filed on May 13, 2003. U.S. Provisional Patent Application No. 60/469,998 is hereby incorporated by reference in its entirety for all purposes as if fully set forth herein.

### BACKGROUND OF THE INVENTION

The general area of the instant invention involves regulation of television viewing through the use of a token operated electronic device. Many parents have difficulty monitoring the television viewing habits of their children due to the time pressures of modern life and the ubiquitous nature of television. One aspect of this difficulty is simply monitoring and enforcing the amount of time of television viewing by children. Previously, either the adult's active participation in the monitoring or the child's cooperation in limiting the amount of television time is required. The most practical result is obviously that the adult is forced to actively monitor and enforce allowable television viewing time.

A number of flaws are apparent when adult supervision of children's television viewing is required. First, having the adult police the period of viewing puts the child at a psychological disadvantage in that the child feels that he or she has no say in the amount of television viewing that is appropriate. Second, that disadvantage can lead to an adversarial position between the adult and the child that strains the relationship between the adult and child. Therefore, an opportunity is lost to allow the child some control over the proper amount of television viewing. Further, another opportunity is lost to allow the child to earn the right to watch an appropriate amount of television by performing familial chores and participating in familial activities.

The instant invention teaches a device that can be used to overcome these problems and to education children in the cost of obtaining the right to view a proper amount of television.

### SUMMARY OF THE INVENTION

The instant invention, the Token-Based TV Viewing Regulator, is an electronic, token activated device that automatically electronically interrupts the television signal to the television monitor. The tokens inserted into the device will allow the signal to pass to the television for a predetermined time period. This period may be determined by the adult. As the child earns television viewing time by receiving tokens for chores or other acts agreed upon by the adult and the child. The child then has the choice of spending the tokens to view television or saving the tokens for a later, extended viewing time. Most important the child is directly involved in deciding the amount of television that can be viewed and the child has a direct choice in how the television time can be spent.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### BRIEF DESCRIPTION OF THE SEVERAL VIEWS OF THE DRAWING

FIG. 1 is a schematic front view of the Token-Based TV Viewing Regulator showing the LED display 4, the token slot 1 located on the top of the device, the on-off power switch 2, key lock 6, and the front of the token receptacle 7.

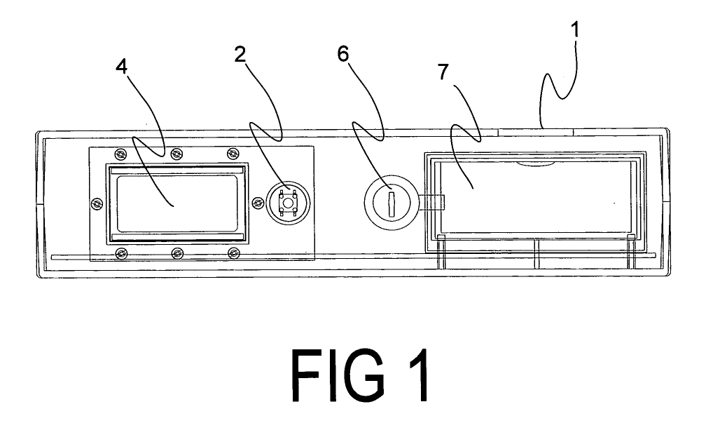

FIG. 2 is a top view of the Token-Based TV Viewing Regulator showing the signal-in bank of connections 29, signal-out bank of connections 28, and AC power connection 5

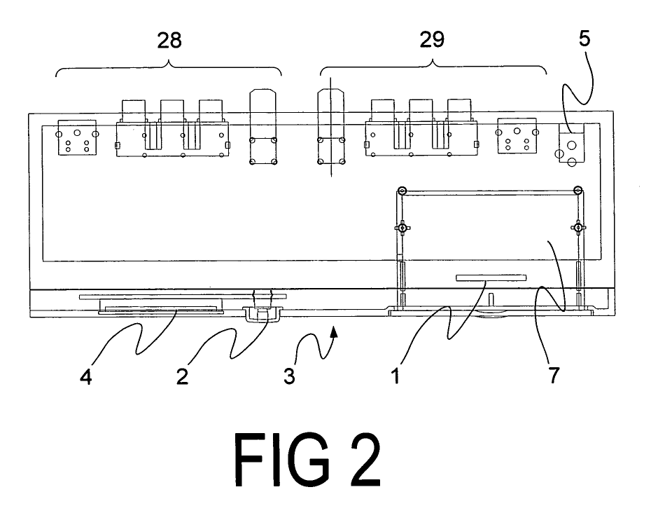

FIG. 3 is a side, cut-away view of the Token-Based TV Viewing Regulator showing the location of the token receptacle 7, the token slot 1 located on the top of the device, and the printed circuit board 30.

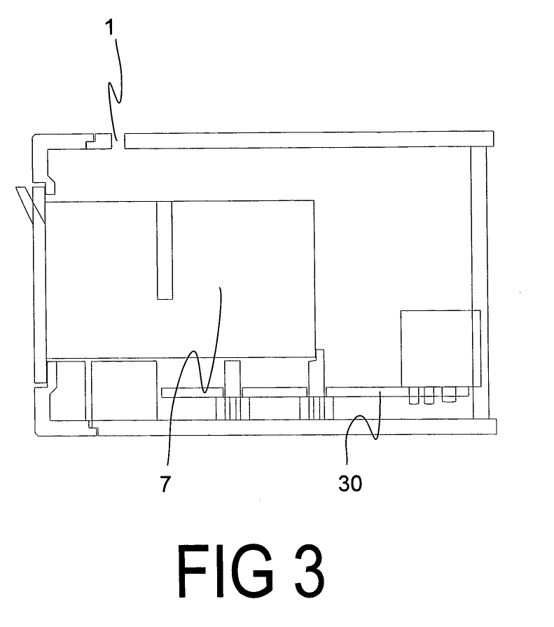

FIG. 4 is an electrical schematic of the Token-Based TV Viewing Regulator electronics.

### DETAILED DESCRIPTION OF THE INVENTION

The Token-Based TV Viewing Regulator is an electronic device that regulates the TV habits of TV viewers by allowing the video signal to television to be interrupted thereby disabling the television. The viewers of the TV is mainly considered to include children, but is comprised of other potential viewing classes such as students, elderly, and hospital patients, or assisted living patents.

The instant invention, the Token-Based TV Viewing Regulator, is an electronic, token activated device that automatically electronically interrupts the television signal to the television monitor. The electronic interruption is a complete disconnection of the television signal from the television cable that normally transmits the television signal to the television. When the tokens are inserted, the device will allow the signal to pass to the television for a predetermined time period. This period is pre-determined by the adult, guardian or administrator of the individual or individuals viewing the television.

In one mode of operation, the viewer is a child and the adult is the parent of the child, and the viewer earns television viewing time by receiving tokens for chores or other acts agreed upon by the adult and the child. The child then has the choice of spending the tokens to view television or saving the tokens for a later, extended viewing time. Most important the child is directly involved in deciding the amount of television that can be viewed and the child has a direct choice in how the television time can be spent.

The instant invention includes a light-emitting diode, LED, indicator 4 showing the time remaining, in minutes, in a digital display. More specifically the LED array is a common cathode, 7-segment LED display. The LED allows the viewer to observe how much time remains in the viewing session and whether additional time should be purchased by inserting additional tokens if available.

The instant invention is comprised of a chassis which is manufactured from plastic or metal. In the preferred mode of the invention the chassis is manufactured from plastic. The chassis forms an aperture, the LED aperture, to allow for mounting of the LED display to allow viewing of the allowed television viewing time remaining. The chassis also contains an aperture, a token slot, 1 for depositing the tokens. Inside the chassis is a token receptacle 7 for storing the tokens after they are inserted into the invention. A keylock 6 secures the token receptacle 7 so that unauthorized users can not access the used tokens.

As a token is deposited into the token slot, the token activates a token sensing means. The token sensing means transmits an electronic signal to a time storage means which stores the amount of time available to the viewer. The time storage means electronically tabulates the amount of available viewing time as tokens are deposited and decrements the available storage time as appropriate. The time storage means decrements the available viewing time regardless if someone is viewing the television or not. The time storage means is electronically connected to the LED display which visually displays the time stored in the time storage means. The Token-Based TV Viewing Regulator is powered by 110 VAC power from house current through a power cord 5. The power cord is in turn connected to a power transformer which supplies appropriate DC power to the time storage means, the LCD display, and the token sensing means. The power to the instant invention may be disconnected through a power switch 2 on the front of the chassis.

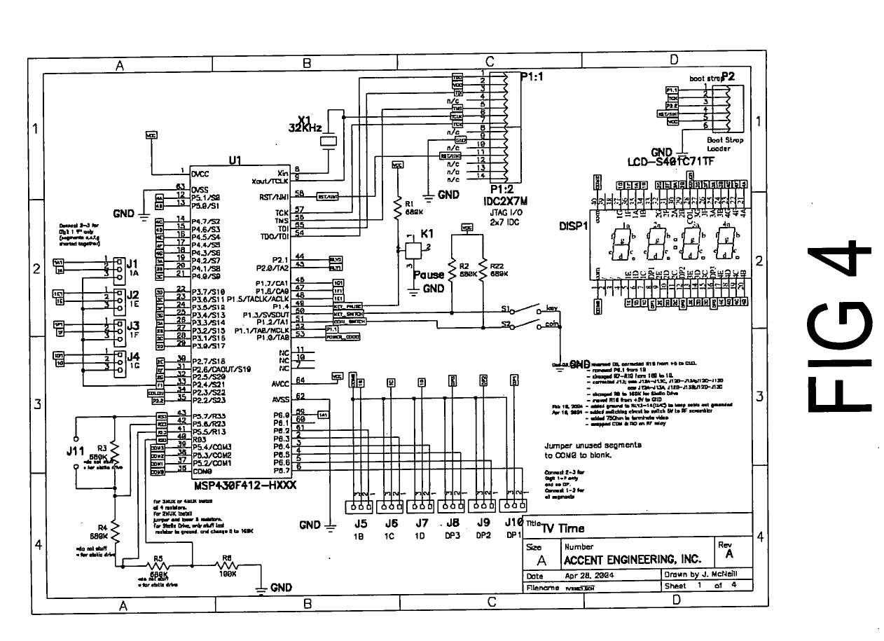

The time storage means is comprised of a 16-Bit ultra-low-power microcontroller, (model no. MSP430F412), a 71′×0.71″ 4 Digit LCD module (model no. LCD-S401C71TF), a 330 Ohm resistor array, a High-Voltage, High-Current Darlington Transistor Array (model no. ULN2003A), a 32 kHz resonator, a 5V regulator a relay coil, a 4.75 kOhm resistor, a bypass switch, and a coin switch. These components are mounted on a printed circuit board 30 that is located inside the chasis. A detailed schematic of the electronics is provided in FIG. 4.

The signal from the antenna or cable TV utility enters the instant invention in the back portion of the chassis. A bank of signal connections for signal-out 28 are provided that provides S-video, video-stereo, and RF connections. A bank of signal connections for signal-in 29 are provided that provides S-video, video-stereo, and RF connections.

Operation

The method of monitoring television viewing by supplying a set number of TV viewing tokens to a user and the user inserts a number of tokens up to but not exceeding the number of tokens supplied to view TV. To initiate the operation of the television viewing regulator by a television viewer the viewer inserts one or more tokens into the token slot. The insertion of the tokens initiates a time storage means which increments the amount of available viewing time proportionally to the number of tokens inserted. The coin activates the time storage means which tabulates the amount of available viewing time for each deposited token. Additional tokens increments the amount of available viewing time. The time storage means closes the bypass switch allowing the cable television signal to pass uninterrupted through the instant invention and out to the television. Next, the time storage means begins to decrements the amount of available viewing time and calculates and records an adjusted viewing time, and displays the adjusted viewing time on a light-emitting diode digital display in view of the television viewer. As the viewer is watching television, the time storage device decrements the amount of viewing time remaining and updates the LED display showing the amount of viewing time remaining. The time storage means then initiates a comparison step where the adjusted viewing time is compared with zero. When the amount of viewing time reaches zero, the time storage device opens the bypass switch and interrupts the electronic signal to the television. The user can add more viewing time by inserting a token in to the coin slot aperture. A parent or guardian of an individual can thereby remotely monitor the amount of TV viewing by supplying a set number of TV viewing tokens to a user and the user inserts a number of tokens up to but not exceeding the number of tokens supplied to view TV.

Abstract of the Disclosure

The instant invention, the Token-Based TV Viewing Regulator, is an electronic, token activated device that automatically electronically interrupts the television signal to the television monitor. The electronic interruption is a complete disconnection of the television signal from the television cable that normally transmits the television signal to the television. When the tokens are inserted, the device will allow the signal to pass to the television for a predetermined time period. This period is pre-programmed to limit the viewing time to 30 minutes. The instant invention includes a light-emitting diode, LED, indicator showing the time remaining, in minutes, in a digital display. The LED allows the viewer to observe how much time remains in the viewing session and whether additional time should be purchased by inserting additional tokens if available. Finally, an on-off switch is included to disable the device.

1) A television viewing regulator comprising a token activated device with a means to automatically electronically interrupt a television signal to a television monitor.

2) The television viewing regulator of claim 1, the means to automatically electronically interrupt a television signal to a television monitor further comprising:
(a) a chassis, a light-emitting diode digital display,
(b) an aperture for the light-emitting diode,
(c) a aperture in the chassis forming a token slot,
(d) a receptacle for storing tokens,
(e) a time storage means,
(f) and an electronic connection allowing communication between the time storage means and the digital display.

3) The television viewing regulator of claim 2, the time storage means further comprising:
(a) a 16-bit ultra-low-power microcontroller,
(b) a 71′×0.71″ 4 Digit LCD module,
(c) a 32 kHz resonator.

4) The television viewing regulator of claim 3, the time storage means further comprising:
(a) a bypass switch, and
(b) a token activated switch.

5) A method of monitoring television viewing comprising:
(a) supplying a set number of TV viewing tokens to a television viewer,
(b) initiating the operation of the television viewing regulator by a television viewer by inserting one or more tokens into the token slot,
(c) initiating the operation of the television viewing regulator initiates a time storage means which increments the amount of available viewing time proportionally to the number of tokens inserted,
(d) initiating the time storage means which decrements the amount of available viewing time, calculates an adjusted viewing time, and displays the adjusted viewing time on a light-emitting diode digital display in view of the television viewer,
(e) initiating a series of time decrementing steps initiates a comparison step where the adjusted viewing time is compared with zero,
(f) initiating a comparison step increments a communication interruption step where all electronic video signals to a television are interrupted.

6) The method of monitoring television viewing in claim 5, with the process being reinitiated by supplying additional TV viewing tokens to a television viewer.
